(19) United States
(12) Patent Application Publication
(10) Pub. No.: US 2020/0282959 A1
(43) Pub. Date: Sep. 10, 2020

(54) HIGH PRESSURE CHEMICAL FOAMER FOR COMMERCIAL CAR WASHING SYSTEMS

(71) Applicant: Peter J. Anderson, Creedmoor, NC (US)

(72) Inventor: Peter J. Anderson, Creedmoor, NC (US)

(21) Appl. No.: 16/813,333

(22) Filed: Mar. 9, 2020

Related U.S. Application Data
(60) Provisional application No. 62/815,807, filed on Mar. 8, 2019.

(51) Int. Cl. B60S 3/04

(52) U.S. Cl. CPC B60S 3/04; B60S 3/004

(57) ABSTRACT

A chemical delivery and foam generating system having a high pressure pump for pressurizing a wash fluid source to a pressure at or above 500 psi in a commercial car wash. The system includes a first eductor in fluid communication with the high pressure pump, the first eductor having at least one inlet for receiving a liquid chemical from bulk supply and located at an off-board position. A second eductor is positioned at an on-board position and includes one inlet for receiving ambient air. An elongated high pressure hose extends between the first eductor and the second eductor. At least one foam discharge nozzle is coupled to the second eductor to dispense foamed chemical onto the vehicle.

### CROSS-REFERENCE TO RELATED APPLICATION

This application claims priority to and the benefit of U.S. provisional patent application No. 62/815,807, filed on Mar. 8, 2019, entitled “Two-Stage Eduction High Pressure Chemical Foamer for Commercial Car Washing”, the entirety of which is incorporated herein by reference in its entirety for all purposes.

### TECHNICAL FIELD

This disclosure relates to vehicle wash systems, and in particular, to chemical solution application and foam volumizing devices for use in vehicle wash systems, and more specifically, to chemical applicators and foamers for commercial carwashing systems.

### BACKGROUND

According to the United States Census Bureau, over 100,000 car wash facilities are located in the United States with consumers spending approximately $5.8 billion. These facilities include tunnel type, where vehicles are pulled through a long narrow building on a conveyor so as to be exposed to various wash components for processing the vehicle exterior. Other facilities are of the self-service type, where the car is pulled into a wash bay, the customer remits payment at a payment station, and then manually washes the car using high pressure wands and brushes. Still other types of facilities include in-bay automatic washes (commonly found in conjunction with convenience stores) where payment is made at a payment station and, the vehicle is driven into and parked inside of a wash bay, and once in the wash bay, the wash unit moves back and forth over the vehicle to carry out various wash functions.

The above-described systems typically utilize one or more air compressors to generate foam for volumizing cleaning and conditioning chemicals for eventual application onto vehicles. The chemicals are volumized for several reasons. For example, when the chemicals, especially cleaning detergents, are volumized, they cause the chemical application to stick to the surface of the vehicle long enough for a thorough wash process to take place. Additionally, the foam expansion of the chemical provides the customer a clear visual display to verify that product has been applied to the vehicle. For these and other reasons, foaming chemicals is extremely important to the success of a carwash.

However, such air compressors are expensive to operate, are bulky (a typical size including an 80 gallon storage tank), and require motors to drive reciprocating piston pumps to compress the air. All of this equipment requires extra space in an equipment room, are costly to operate, expensive to repair, difficult to installs, and are noisy during operation. Furthermore, the resulting condensed water vapor generated during operation must be frequently drained. In view of the foregoing, air compressors are generally regarded as an inconvenience for carwash operators. There is a need to overcome these deficiencies.

### SUMMARY

Commercial carwashing systems incorporate multiple sequential processes during operation. For example, in a first step, the vehicle is generally soaked with a cleaning detergent. The detergent is in water solution, commonly referred to as a “presoak”, where the detergent is volumized with air to produce foam. The foam is deposited in a thin even layer onto the vehicle so that the soil on the vehicle surface can be emulsified. In a second cycle step, the emulsified soil and detergent is removed from the vehicle with high pressure water. In an optional third step, the vehicle may be soaked again with a protective water-based clear coat conditioner (commonly called triple foam, lava shield, or overglow), where the conditioner is volumized with air into a foam and deposited onto the vehicle. Finally, a high pressure spot-free rinse removes the conditioner.

Embodiments disclosed herein provide a method of generating foam without the need of an air compressor. According to some embodiments, a pump pressurizes water to approximately 2000 psi and pushes water through the open valves, a close proximity downstream venturi type chemical injector causes the water pressure to drop approximately 60-70% past the injector to approximately 800 psi. After traveling out to the wash bay through high pressure hosing, another venturi injects ambient air into the water/solution stream just before a foaming dispersion screen, and then the final part is a pattern optimizing nozzle before deposition onto the vehicle.

Other aspects, features, and advantages will become apparent from the following detailed description when taken in conjunction with the accompanying drawings, which are a part of this disclosure and which illustrate, by way of example, principles of the inventions hereof.

### DESCRIPTION OF THE FIGURES

The accompanying drawings facilitate an understanding of the various embodiments.

FIG. 1 illustrates a portion of a commercial car wash incorporating a chemical mixing and foam generating system in which a two-stage eduction high pressure chemical foamer is employed to advantage.

FIG. 2 illustrates another embodiment of portion of a commercial car wash incorporating a chemical mixing and foam generating system.

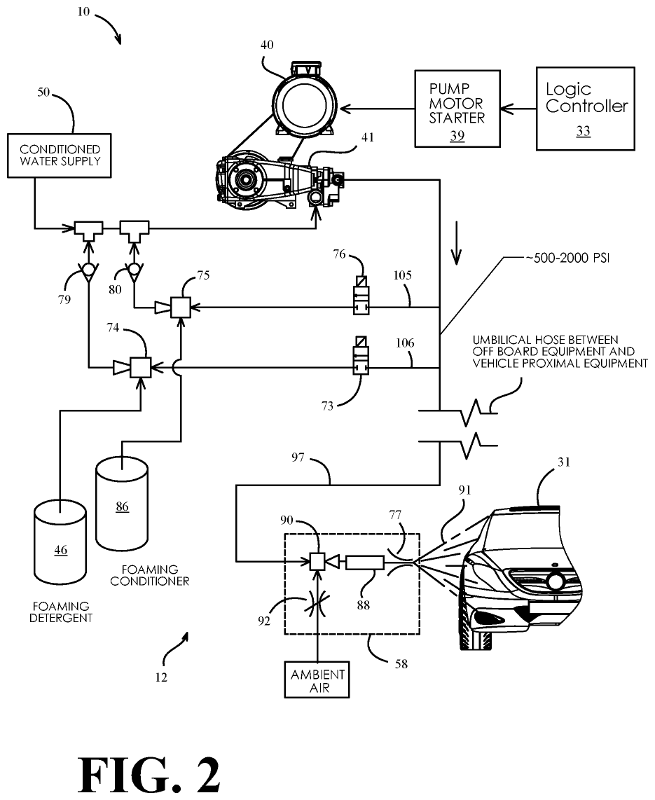

FIG. 3 illustrates an in-bay automatic wash system in which an embodiment of a two stage eductor high pressure foamer is employed to advantage.

FIG. 4 is a detail of a portion of the systems illustrated in FIGS. 1-3.

### DETAILED DESCRIPTION

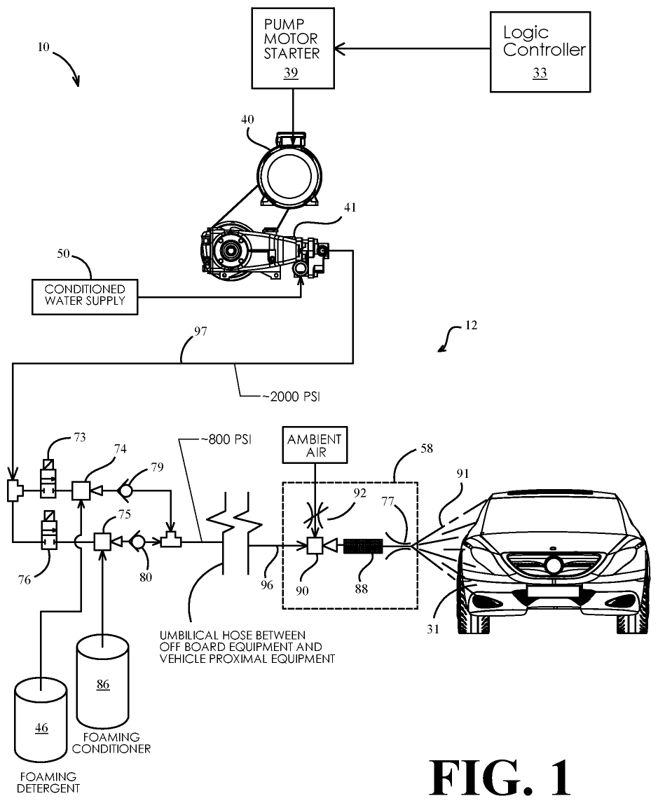

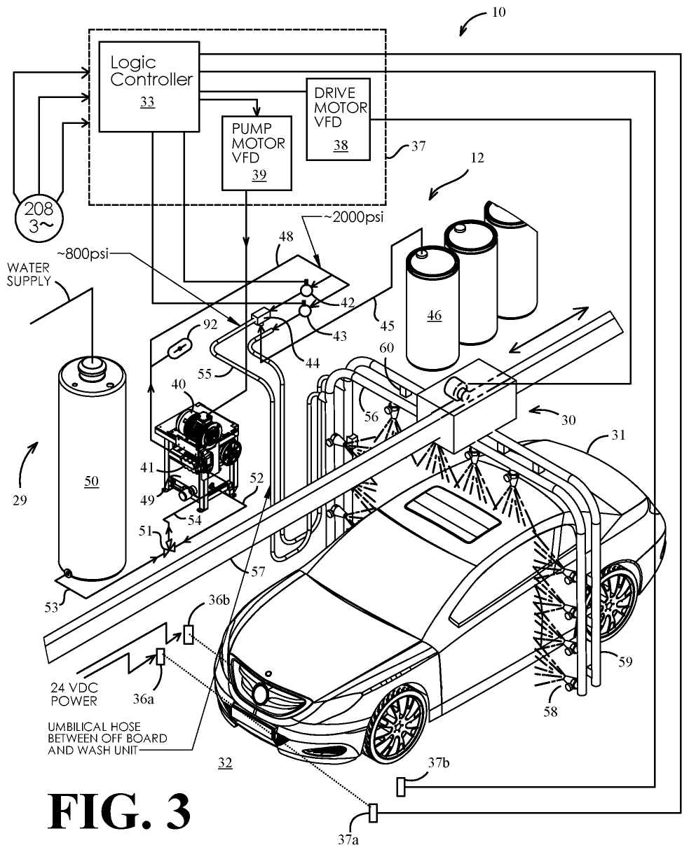

FIG. 1 illustrates a portion of a commercial car wash 10 incorporating a chemical mixing and foam generating system 12 in which a two-stage eduction high pressure chemical foamer is employed to advantage. In the embodiment illustrated in FIG. 1, system 12 includes a variable frequency drive (“VFD”) motor 40 for driving a pump 41. A logic controller 33 is operable to, among other things, vary the speed of the motor 40 to, as discussed in greater detail below, maintain a desired fluid pressure in the system 12. According to some embodiments, the motor 40 drives the high pressure water pump 41 to pump water from a conditioned water supply 50 at a pressure of approximately 2000 psi through a main pressure line 97. A pair of selector valves 73 and 76 are actuated to control water flow through respective eductors 74 and 75 so as to draw in a chemical from storage drums 46 and 86, respectively. According to some embodiments, the selector valve includes a solenoid actuated valve. In the embodiment illustrated in FIG. 1, storage drum 46 stores a foaming detergent and storage drum 86 stores a foaming conditioner. In a typical commercial car wash environment, for safety reasons, noise reduction, and due to limited space availability in a wash bay 32 (See FIG. 3) where vehicles are washed, equipment such as, for example, the logic controller 33, the motor 40, the pump 41, the eductors 74, 75, the storage drums 46 and 86 and other components of the system 10 are disposed in an adjacent equipment room 29 (FIG. 3) away from the wash bay 32.

In operation, as the water flows through the eductors 74, 75, the water pressure drops 60-70%. The water is pumped through a feed hose 96 from an “off-board” location, such as, for example, the remote equipment room 29, where the off-board equipment is located, to a foam nozzle assembly 58, which is “on-board” and in the proximity of a vehicle 31, typically in the wash bay 32. As discussed more fully below, ambient air is pulled into the nozzle assembly 58 and discharged therefrom and onto the vehicle 31 in the form of a fine foam mixture 91. Check valves 79 and 80 prevent reverse fluid flow through the system.

It should be understood that the term “off-board” means at a position so as not to directly perform wash functions, such as, for example, positioned in an equipment bay/room 29, or disposed on a wall in the wash bay 32, or any other location not in close proximity with the wash process. It should be understood that the term “on-board” means positioned to directly perform wash functions, such as, for example, positioned in a wash bay 32 as part of a car washing machine 30, a rinse arch 59 or otherwise in close proximity to the vehicle being washed.

Oftentimes, multiple chemical applications occur simultaneously. In order to accommodate the simultaneous applications, the pump being utilized is rated for the 100% maximum flow at any given moment in time; however, there may be instances where only a portion of the high pressure water is demanded from the pump. In this case, for example, if only 10% of the fluid flow volume is required, then the pump would only run 10% of rated speed.

In operation, the VFD pump motor 40 detects amperage draw, and based on the detected level, adjusts motor output and thus, the speed of the pump 41 so as to maintain system pressure.

Referring now to FIG. 3, a second embodiment of a system 12 is a pair of auxiliary lines 105 and 106 are branched off the high pressure line 97 and, in response to selectively operating solenoids 73, 76, a portion of the water from the high pressure 76 line is directed through the correspondingly selected eductor 74, 75. In operation, the eductor 74, 75 pulls in the chemical from the applicable drum 46, 86, and the solution is directed into the low pressure intake of the high pressure pump 41. Accordingly, chemical is introduced to create a high pressure solution maintained at, according to some embodiments, the full 2000 psi pressure, without significantly reducing solution pressure and velocity through the foam assembly nozzle 58. It should be noted that according to some embodiments, chemical dosing pumps (not illustrated), a solenoid controlled gravity feed, or other type of method could be used to inject chemicals upstream of the high pressure pump 41.

FIG. 3 illustrates an in-bay automatic wash system 10, wherein a wash bay 32 houses an in-bay automatic carwashing machine 30 and an adjacent equipment room 29 housing the main electrical panel 37 and the off-board equipment, including, for example, the motor 40, the pump 41 and storage drums 46 and 86. In the embodiment illustrated in FIG. 3, the main electrical panel 37 includes the logic controller 33, the VFD pump motor starter 39 and a VFD motor drive 38, to, as discussed in greater detail below, drive the car washing machine 30 located in the wash bay 32. In operation, an array of thru-beam sensors 36a, 36b, 37a and 37b at the front of the wash bay 32 detect the presence of a vehicle 31 in the wash bay 32. Once the vehicle 31 is in place, the logic controller 33 carries out a sequence of preconfigured wash cycles, as discussed in greater detail below.

In operation, the first pass is generally a soil emulsifying detergent or “presoak” pass. During the presoak pass cycle, the logic controller 33 signals the VFD motor 39 to start motor 40, which is drivingly connected to the high pressure pump 41. Simultaneously, the logic controller 33 signals 3-way valve 51 to actuate, enabling the suction lines 52 and 54 to be in fluid communication causing the high pressure pump 41 to draw water from conditioned water supply 50 through line 53 and pressurize a water feed hose 48 to approximately 2000 psi. Simultaneously, the logic controller 33 signals high pressure valve 42 to open, allowing the high pressure water to travel downstream through a suitably sized eductor 44. As the feed water passes through the eductor 44, the pressure drops to approximately 800 psi thereby creating a vacuum in chemical feed line 45 to pull detergent from the bulk detergent drum 46. Meanwhile, a flexible high pressure hose 55 directs the detergent solution from the off-board area (i.e., the equipment room 29) to the on-board machine 30 in the wash bay 32 and connecting to the presoak arch 56 for distribution about the surface of the vehicle 31. The logic controller 33 signals VFD drive motor 38 to drive the on-board machine reciprocally over the vehicle 31 along support beam 57 while presoak is discharged out of foam nozzle expansion assemblies 58, as discussed in greater detail below.

According to some embodiments, in one or two passes, the volumized detergent covers the vehicle 31 and the logic controller 33 switches to a high pressure rinse cycle to wash remaining soil and detergent off of the vehicle 31. For the rinse pass, the logic controller 33 maintains the high pressure pump on and actuates the 3-way valve 51 so as to connect the pump intake to draw from the tank 50, and actuate a high pressure water valve 43 so as to cause rinse water to exit from the machine 30, flow onto a rinse arch 59, and dispense through rinse nozzles 60 and onto the vehicle 31. Similar to the presoak pass, the logic controller 33 will then signal the VFD drive motor 38 to cause the machine 30 to pass over the vehicle 31 while rinsing takes place.

Embodiments disclosed herein enable both high pressure presoak solution and high pressure rinsing take place with the same high pressure pump and an air compressor is not required for presoak foam.

It should be understood that in connection with in-bay automatics, the discussion herein includes simplified examples, and in some embodiments, there are many more potential foamed chemicals that may be applied to the vehicle during an entire wash, such as chemical tire application, clear coat conditioner, “rain-ex” final sealer, secondary multi-color, or multi-scented detergents, etc. Therefore, there may be a greater or fewer number of storage drums 46 and 86 with many different stored liquid chemicals and the detergent foaming and application system may be mimicked and scaled accordingly to accommodate other chemistry for other applications.

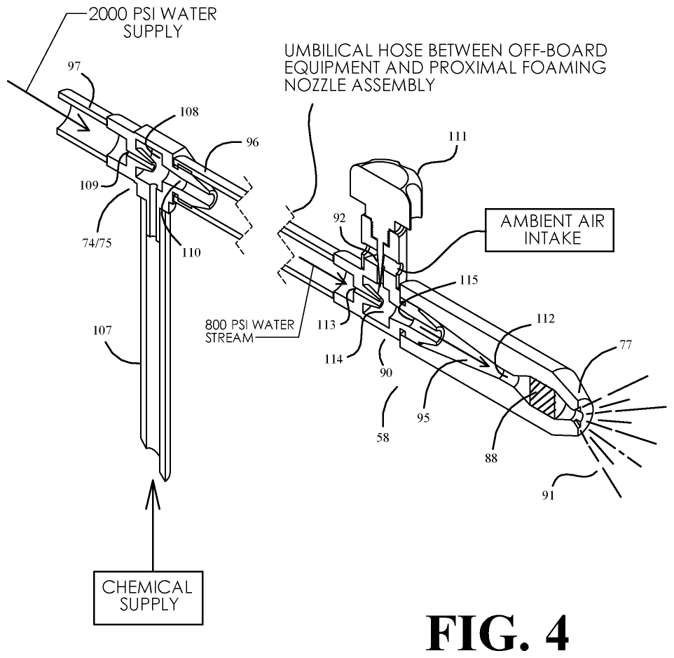

Referring now to FIG. 4, a sectional detail view of the eductor 74, 75 and the foaming assembly 58 is illustrated in the context of the two-stage eductor embodiment wherein the high pressure 2000 psi main supply 97 feeds a first high pressure eductor 74 or 75. As previously discussed, the eductors 74, 75 are located off-board in a location, such as, for example, an adjacently positioned equipment room 29. The eductors 74, 75 include a water inlet, an orifice 109 which controls and restricts the solution flow, a vacuum chamber 108, which allows the drawing in of wash chemicals into solution through tube 107 and a Bernoulli effect acceleration chamber 110 creating the vacuum. After passing through the eductor 74, 75, the water pressure drops, in accordance with one embodiment, by 60-70% to approximately 800 psi and moved through an extended length high pressure umbilical hose 96 and terminating into the foam generating nozzle assembly 58, which lies in close proximity to the vehicle 31 to be washed.

With reference to FIGS. 3 and 4, the foaming assembly 58 includes an eductor 90 having a solution inlet with a reducing orifice 113 to control and restrict solution flow. The foam eductor 90 further includes a vacuum chamber 114 to allow ambient air to be pulled in, an air intake flow control 92 to control how much foaming aeration is pulled in, an air intake flow knob 111 control to manually control the aeration by increasing or decreasing the air passageway size, and a Bernoulli effect acceleration chamber 115 to create a vacuum to pull in the ambient air. According to some embodiments, the pressure at this point drops another 60-70% to (200-300 psi at the lower end of the scale) and is pushed through a foam generating screen 88 for optimal agitation. Thereafter, the foam exits the nozzle 77 and is directed onto the vehicle 31.

This method of foam generation allows a much higher pressure, volume, and foam density without the use of an air compressor. Prior art methods utilize an air compressor and the exit foam pressure would not exceed more than 60 psi. In certain embodiments disclosed herein, the exit pressure will typically range from 180 to 750 psi depending on initial pump water pressure, although it should be understood that the range could be less than 180 psi or greater than 750 psi.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In the specification and claims, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s), as defined solely by the appended claims. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A chemical delivery and foam generating system comprising:
a high pressure pump for pressurizing a wash fluid source to a pressure at or above 500 psi;
a first eductor in fluid communication with the high pressure pump, the first eductor having at least one inlet for receiving a liquid chemical from bulk supply;
wherein the high pressure pump and the first eductor are located off-board;
a second eductor positioned on-board, the second eductor having at least one inlet for receiving ambient air and a second inlet for receiving the wash fluid source;
an elongated high pressure hose extending between the first eductor and the second eductor; and
at least one foam discharge nozzle coupled to the second eductor to dispense foamed chemical onto the vehicle.

2. The system of claim 1, wherein the second eductor is downstream from the first eductor.

3. The system of claim 1, wherein the first eductor is disposed in an equipment room spaced apart from the wash bay.

4. The system of claim 1, wherein the second eductor decreases the wash fluid pressure.

5. The system of claim 1, wherein a variable frequency drive controls a pump motor so as to maintain the line pressure.

6. The system of claim 1, wherein the high pressure pump pressurizes the wash fluid pressure to around 2000 psi.

7. The system of claim 1, wherein the first eductor is a dosing pump.

8. The system of claim 1, wherein the first eductor decreases the pressure of the wash fluid source.

9. The system of claim 1, wherein the first eductor has an outlet, the outlet being in fluid communication with a low pressure inlet of the high pressure pump.

10. The system of claim 1, further comprising multiple selector valves to selectively include washing chemicals in the wash fluid.

11. A chemical delivery and foam generating system for washing a vehicle, the system comprising:
a motor;
a pump for pumping high pressure water through the system;
a controller communicatively coupled to the motor and operable to receive a signal indicative of a motor current corresponding to a system water pressure such that in response to receiving such signal, the controller varies the speed of the motor to maintain system water pressure;
a first eductor in fluid communication with the pump, the eductor having at least one inlet for receiving a liquid chemical;
the motor, pump, controller and eductor located off-board;
an elongated hose extending from the eductor to a foaming assembly, the foaming assembly located on-board and including a second eductor having an inlet to receive ambient air and an outlet fluidly coupled to an exit nozzle for discharging foam onto a vehicle.

12. The system of claim 11, wherein the first eductor further includes a solution inlet with a reducing orifice restrict solution flow.

13. The system of claim 11, wherein the first eductor further includes a vacuum chamber for pulling ambient air into the eductor, the eductor including an air intake flow control to control the rate of ambient air being pulled into the eductor.

14. The system of claim 11, wherein the first eductor causes a pressure drop of at least 50 percent of system water pressure.

15. The system of claim 11, wherein the second eductor is downstream the first eductor.

16. The system of claim 11, wherein the foaming assembly is disposed on-board in a wash bay in proximity of a vehicle to be washed.

17. The system of claim 11, wherein the pump pressurizes the system pressure to at least 500 psi.

18. The system of claim 11, wherein the pump pressurizes the system water pressure to around 2,000 psi.

19. A chemical delivery and foam generating system for washing a vehicle, the system comprising:
a motor;
a pump for pumping high pressure water through the system;
a controller communicatively coupled to the motor and operable to receive a signal indicative of a motor current corresponding to a system water pressure such that in response to receiving such signal, the controller varies the speed of the motor to maintain system water pressure at a predetermined level;
at least one eductor, the eductor having an inlet for receiving a liquid chemical and an outlet in fluid communication with a low pressure inlet of the pump for supplying liquid chemical to the high pressure pump;
the motor, pump, controller and first eductor disposed off-board; and
an elongated hose extending from the pump to a foaming assembly to provide high pressure water thereto, the foaming assembly located on-board in a wash bay and including a second eductor having a first inlet to receive the high pressure water, a second inlet to receive ambient air, and an outlet fluidly coupled to an exit nozzle for discharging foam onto a vehicle, wherein the eductor is configured to reduce the system water pressure prior to discharging the foam through the exit nozzle.

20. The system of claim 19, wherein the pump pressurizes the system pressure to at least 500 psi.
